(19) United States
(12) Patent Application Publication
(10) Pub. No.: US 2024/0312226 A1
(43) Pub. Date: Sep. 19, 2024

(54) ANALYZING A ROUNDABOUT

(71) Applicant: CONNAUGHT ELECTRONICS Ltd., Tuam, County Galway (IE)

(72) Inventors: Akhilesh Kumar Malviya, Chennai (IN); Arindam Das, Chennai (IN); Senthil Kumar Yogamani, Tuam, County Galway (IE)

(73) Assignee: CONNAUGHT ELECTRONICS Ltd., Tuam, County Galway (IE)

(21) Appl. No.: 18/576,750

(22) PCT Filed: Jul. 5, 2022
(86) PCT No.: PCT/EP2022/068527

§ 371 Date: Jan. 5, 2024

(30) Foreign Application Priority Data
Jul. 5, 2021 (DE) 102021117227.6

(51) Int. Cl. G06V 20/56; G01C 21/36; G06T 7/62; G06V 10/764; G06V 10/82

(52) U.S. Cl. CPC G06V 20/588; G01C 21/3602; G06T 7/62; G06V 10/764; G06V 10/82; G06T 2207/20076; G06T 2207/20084; G06T 2207/30252

(57) ABSTRACT

A computer-implemented method for analyzing a roundabout in an environment for a vehicle is disclosed. The method includes generating at least one initial feature map by applying a feature encoder module of a trained neural network to an input image. The input image depicts the roundabout. The method includes next applying a classificator module of the trained neural network to the initial feature map. An output of the classificator module represents a road region on the input image. The method includes next applying a radius estimation module of the trained neural network to the initial feature map. An output of the radius estimation module depends on an inner radius of the roundabout and an outer radius of the roundabout. The method includes finally determining an entry point and an exit point of the roundabout depending on the output of the classificator module and depending on the output of the radius estimation module.

The present invention is directed to a computer-implemented method for analyzing a roundabout in an environment of a vehicle, to a computer-implemented method for planning a path for a vehicle, to an electronic vehicle guidance system and to a computer program product.

Computer vision algorithms may be used in various ways for autonomous or semi-autonomous driving tasks as well as for driver assistance systems. In this context, an accurate path planning is important from a functional point of view and from a security point of view. Paths for vehicles may be planned for different reasons. For example, for fully autonomous driving, a path may be planned to guide the vehicle from a starting location to a destination. Also in the context of emergency braking systems, lane assisting systems et cetera, paths of different lengths are planned by a computing unit of the respective vehicle.

One challenging situation for human drivers as well as for automatic or semi-automatic systems are roundabouts, also denoted as rotaries or traffic circles. Known planning algorithms are able to plan a path for a vehicle to guide the vehicle to an exit point of the roundabout when the vehicle is driving in the roundabout or from an entry point to an exit point of the roundabout, when the vehicle is not yet driving in the roundabout. Such path planning algorithms may, for example, use, amongst a variety of further inputs, a location of an entry point at which the vehicle has entered the roundabout or will enter the roundabout and/or a location of an exit point at which the vehicle will leave the roundabout. In particular, if camera images are used as a basis for the path planning algorithms, such an algorithm may require a respective position of the entry and/or exit point in the camera image or an image obtained by processing the camera image at each given time.

Document US 2020/0211379 A1 describes a roundabout assistance system. Therein, a navigation system is used to identify the roundabout on a route for a primary object, such as a vehicle, which is about to enter the roundabout. The system is able to detect and track secondary objects in the roundabout to inform the primary object when it is safe to enter the roundabout. Therein, a neural network may be used for vehicle detection and computer vision algorithms may be deployed on detected objects to compute relevant metrics, such as position, heading and velocity.

It is an object of the present invention to provide a possibility to automatically analyze a roundabout and to automatically provide input data suitable for being used by a subsequent path planning algorithm.

This object is achieved by the respective subject-matter of the independent claims. Further implementations and preferred embodiments are subject-matter of the dependent claims.

The invention is based on the idea to encode an input image, which depicts the roundabout, by means of a trained artificial neural network and to use the encoded initial features to determine at least one entry point and/or at least one exit point of the roundabout.

According to a first aspect of the invention, a computer-implemented method for analyzing a roundabout in an environment of a vehicle is provided. Therein, at least one initial feature map is generated by applying a feature encoder module of a trained artificial neural network to an input image, wherein the input image depicts the roundabout at least partially. A classificator module of the trained artificial neural network is applied to the at least one initial feature map, wherein an output of the classificator module represents a road region in the input image, wherein the road region in the image, in particular, depicts a corresponding road region in the environment. A radius estimation module of the trained artificial neural network is applied to the at least one initial feature map, wherein an output of the radius estimation module depends on an inner radius of the roundabout and an outer radius of the roundabout. At least one entry point and/or at least one exit point of the roundabout are determined depending on the output of the classificator module and depending on the output of the radius estimation module.

Here and in the following, all steps of a computer-implemented method may be carried out by one or more computing units, in particular of the vehicle, if not stated otherwise. In particular, the one or more computing unit may comprise one or more central processing units, CPUs, one or more electronic control units, ECUs, of the vehicle, one or more digital signal processing units, DSPs, one or more graphics processing units, GPUs, one or more systems-on-a-chip, SoCs, et cetera.

The input image may, for example, be generated based on at least one camera image. In particular, the at least one camera image may comprise two or more camera images, which may be generated, for example, by respective cameras mounted on the vehicle and having different fields of view covering respective different portions of the environment of the vehicle. For example, the at least one camera may comprise a front camera, a rear camera, a left camera and/or a right camera mounted at respective positions and with respective orientations on the vehicle. The input image may, for example, correspond to a combination of respective images from the at least two cameras, for example to a stitched or merged image of the respective camera images. For example, the camera images may be converted or transformed to a top view and the converted camera images may then stitched in order to generate the input image.

A roundabout may, for example, be understood as an intersection of two or more roads with an island in the middle of the roundabout, wherein road traffic is intended to drive around the island from an entry point of the roundabout to an exit point of the roundabout. In particular, the roundabout has at least two entry points and at least two exit points. The geometrical shape of the island may be approximately circular. Then, the drivable region of the roundabout may, for example, be approximated by a ring with an inner ring radius corresponding to the inner radius of the roundabout and an outer ring radius corresponding to the outer radius of the roundabout.

In the following, it is assumed that the roundabout can be at least approximately described by such a ring. In particular, also hexagonal or octagonal islands and correspondingly shaped drivable regions may form roundabouts that may approximately be described by a circular ring.

That the roundabout is present in the environment of the vehicle may, for example, be understood such that the roundabout is located on a road the vehicle is currently driving on or that the vehicle is already driving in the roundabout.

The trained artificial neural network, which is in the following also denoted as neural network, may comprise a plurality of blocks or modules including the feature encoder module, the radius estimation module and the classificator module. A module can also comprise one or more sub-modules. A module or sub-module may be trainable or not. In particular, the classificator module and the radius estimation module each comprise trainable parameters. When the computer-implemented method is carried out, these parameters have been trained already.

The feature encoder sub-module may, in particular, comprise one or more convolutional layers such that the spatial dimensions of the at least one feature map are, in general, different from the spatial dimensions of the input image. For example, the feature encoder module may be designed to reduce the spatial dimension of the input image. Apart from the one or more convolutional layers, further layers such as pooling layers, dropout layers et cetera may be comprised by the feature encoder module.

According to some implementations of the method, a known pre-trained feature encoder module may be used, for example a VGG encoder, a ResNet encoder, an inception encoder, et cetera.

The classificator module is used to generate its output containing or representing the road region in the input image. The road region corresponds to one or more connected regions in the input image depicting a corresponding part of the road in the environment. To this end, the classificator module may classify the input image on a pixel level or on a larger scale level. The classificator module may, for example, be designed as a decoder module comprising one or more de-convolutional layers in order to scale up the at least one feature map back to the spatial dimension of the input image. In particular, the number of de-convolutional layers of the classificator module may be equal to the number of convolutional layers of the feature encoder module. In addition, also the classificator module may comprise further layers, such as pooling layers, dropout layers, et cetera.

The classificator module may be a binary classificator, which assigns a probability for two predefined classes to each pixel or region in the input image. One of the classes may correspond to the situation that the corresponding pixel or region is a part of the road region, the other class may correspond to the situation that the pixel or region is not a part of the road region. However, also more complex classificator modules may be used and more than only two classes may be considered. However, at least one of the classes corresponds to a road class and the road region corresponds to the regions in the input image or the pixels of the input image, to which the classificator module has assigned the road class, in particular with a probability or confidence value, which is greater than a predefined minimum value.

When applying the feature encoder module to the input image, the input image is used as an input for the feature encoder module and the feature encoder module generates an output including the at least one initial feature map in response to that input. Analogously, when applying the classificator module to the at least one initial feature map, the classificator module uses the at least one initial feature map as an input and generates the output, which represents the road region. Analogously, when applying the radius estimation module to the at least one initial feature map, the at least one initial feature map is used as an input for the radius estimation module, which then generates the output depending on the inner radius of the roundabout and the outer radius of the roundabout as represented in the input image and encoded in the at least one initial feature map.

That the output of the radius estimation module depends on the inner radius and outer radius of the roundabout and the output of the classificator module represents the road region may be understood such that the output of the radius estimation module comprises information defining or describing the inner and outer radius of the roundabout and the output of the classificator module comprises information defining or representing the road region. This information may, for example, be present in form of respective feature maps generated by the radius estimation module and the classificator module, respectively, or reconstructed images, which may, for example, be generated by decoding the encoded at least one initial feature map accordingly.

In particular, when determining the at least one entry point and/or the at least one exit point depending on the outputs of the classificator module and the radius estimation module, all entry points of the roundabout and all exit points of the roundabout are determined. Here and in the following, determining a point, in particular an entry point or an exit point, may be understood such that a respective location of the point in the input image is determined or, in other words, it is determined which pixel or pixel group of the input image represents the corresponding point.

The at least one entry point or the at least one exit point are determined, in particular, by one or more further modules of the trained neural network including at least one further trainable module.

By means of the computer-implemented method for analyzing the roundabout, the at least one initial feature map generated based on the input image is, in particular, used in parallel to characterize the roads in the environment and also the dimensions of the roundabout in terms of the inner and outer radius. This analysis serves as a basis for determining the at least one entry point and the at least one exit point. Consequently, the at least one entry point and the at least one exit point or, as described above, their respective locations in the input image may be considered to represent a result or a part of a result of the computer-implemented method.

The at least one entry point and/or the at least one exit point may be used for various driver assistance functions or autonomous driving functions, in particular for path planning for the vehicle. For example, the computer-implemented method may be carried out repeatedly for consecutive camera frames and corresponding consecutive further input images. In this way, the location of the at least on entry point and/or the at least one exit point may be tracked over time, which generates valuable input for the path planning. For example, at a given initial time before the vehicle enters the roundabout, the path planning algorithm may have determined an initial source point corresponding to one of the at least one entry points of the roundabout and an initial destination point for the vehicle, which corresponds to one of the at least one exit points of the roundabout. The path for the vehicle may, for example, lead the vehicle from the initial source point to the initial destination point. By means of the computer-implemented method for analyzing the roundabout, the location of the source and destination points may tracked afterwards, in particular, while the vehicle drives in the roundabout.

In some implementations of the computer-implemented method, a vehicle position of the vehicle is determined depending on the output of the classificator module and depending on the output of the radius estimation module.

As described for the entry and exit points of the roundabout, also the vehicle position corresponds to a location in the input image. The vehicle position may, in addition to the at least one entry point and the at least one exit point, be used for path planning.

According to several implementations, two or more camera images are converted to a common top view image in order to generate the input image. In other words, the top view image corresponds to the input image.

The conversion of the two or more camera images may be considered as a pre-processing step prior to analyzing the input image by means of the trained artificial neural network.

Each of the two or more camera images is generated by a different respective vehicle camera mounted to the vehicle. Each of the two or more cameras has a different field of view, wherein the different fields of view may partially overlap. In some implementations, the two or more cameras comprise a front camera, a rear camera, a left camera and a right camera of the vehicle. The front camera has a front facing field of view with respect to the vehicle, the rear camera has a rear facing field of view, the left camera has a left facing field of view, and the right camera has a right facing field of view with respect to the vehicle.

For generating the common top view image, the computing unit may map the individual camera images to individual top view images, for example, by applying an inverse perspective mapping algorithm, and then stitch individual top view images in order to obtain the common top view image and consequently the input image.

According to several implementations, a decision-making module receives the input image or the camera image of the front camera and detects the presence of the roundabout in the environment of the vehicle depending on the input image or the camera image of the front camera. When the presence of the roundabout has been detected, the decision-making module activates a roundabout analyzer module, which comprises the trained artificial neural network. When the roundabout analyzer module has been activated, the steps of generating the at least one initial feature map, applying the classificator module and the radius estimation module and determining the at least one entry point and/or the at least one exit point are carried out. In particular, when the roundabout analyzer module is not activated, said method steps are not carried out.

In this way, computational resources may be saved for other purposes when no roundabout is present. Therein, the presence of the roundabout may, for example, correspond to the roundabout being located in a distance from the vehicle, which is equal to or smaller than a predefined minimum distance.

According to several implementations, the output of the classificator module comprises a segmented image, wherein the road region comprises image points, in particular all image points, of the segmented image, which are assigned to a road class by applying the classificator module to the at least one initial feature map.

The segmented image has, in particular, the same spatial dimensions as the input image or, in other words, each image point of the input image corresponds to a respective image point of the segmented image. The number of de-convolutional layers of the classificator module is therefore equal to the number of convolutional layers of the feature encoder module.

The classificator module may also be denoted as a segmentation module since it produces the segmented image. The segmented image consists of a number of segments, each segment corresponding to a connected region in the segmented image and consequently in the input image, corresponding to the same assigned class, for example the road class.

The classificator module may be implemented as a binary classificator, which is trained to classify the input image or the image points of the input image, respectively, either to the road class or to a not-road class.

In this case, the segmented image may be considered as a feature map with a first channel comprising the information on the road class and a second channel comprising the information on the not-road class. In particular, the first channel may comprise a probability for each image point of the segmented image that the respective image point corresponds to the road class and the second channel may comprise a respective probability that the image point does not belong to the road class.

According to several implementations, the output of the radius estimation module comprises a mask image, which defines a ring with an inner radius approximating the inner radius of the roundabout and with an outer ring radius approximating the outer radius of the roundabout.

Therein, the mask image has the same spatial dimensions as the input image or, in other words, the radius estimation module comprises a number of de-convolutional layers which is equal to the number of convolutional layers of the feature encoder module.

The mask image may be considered as a binary image or black and white image, wherein all image points of the mask image between the inner ring radius and the outer ring radius have a first value, and the remaining image points of the mask image have a second value. The image points with the first value may, for example, be considered as white pixels, and the image points with the second value as black pixel or vice versa.

In other words, the mask image represents the portion of the input image or defines the portion of the input image, which corresponds to the circular road part or approximately circular road part of the roundabout.

According to several implementations, the radius estimation module comprises a radius regression sub-module and a masking sub-module. The radius regression sub-module may generate a radius feature map depending on the at least one initial feature map and the masking sub-module may then identify the inner ring radius and the outer ring radius depending on the radius feature map and generate the mask image accordingly.

According to several implementations, applying the radius estimation module to the at least one initial feature map comprises applying the radius regression sub-module to the at least one initial feature map and an output of the radius regression sub-module comprises the radius feature map. The radius feature map comprises a first channel comprising a probability for each image point of the input image that the respective image point corresponds to a center of the roundabout. The radius feature map comprises a second channel comprising a regression value for the inner radius of the roundabout for each image point of the input image, and the radius feature map comprises a third channel comprising a regression value for the outer radius of the roundabout for each image point of the input image.

In other words, considering a certain point in the input image as the center of the roundabout, the first channel provides the respective probability that this is actually the case and the second and third channel deliver the respective inner and outer radius.

According to several implementations, applying the radius estimation module to the at least one initial feature map comprises applying the masking sub-module to the radius feature map and to determine the inner ring radius and the outer ring radius as an output of the masking sub-module.

According to several implementations, a global maximum of the first channel of the radius feature map is determined by the masking sub-module. The inner ring radius is determined by the masking sub-module as the regression value for the inner radius of the roundabout corresponding to the global maximum. The outer ring radius is determined by the masking sub-module as the regression value for the outer radius of the roundabout corresponding to the global maximum.

The global maximum of the first channel represents the global maximum probability for the image points of the input image to be the center of the roundabout. Correspondingly, the global maximum defines an image point, which has the highest probability that this is actually the center of the roundabout. The inner ring radius and the outer ring radius are then determined as the values of the second and third channel of the radius feature map corresponding to the image point with the global maximum.

According to several implementations, a road regression module of the trained neural network is applied to a combination of the segmented image and masked image and an output of the road regression module comprises a road points feature map. The at least one entry point and/or the at least one exit point are determined depending on the road points feature map.

The combination of the segmented image and the masked image may, for example, correspond to a stacked image given by a stack of the segmented image and the masked image. In other words, the segmented image and the masked image may be concatenated by applying a stack module of the trained artificial neural network to the segmented image and the masked image. The stacked image has, in particular, the same spatial dimensions as the segmented image and the masked image and the number of channels of the stacked image is given by the number of channels of the segmented image plus the number of channels of the masked image. For example, the masked image and the segmented image may have only one channel, repectively, such that the stacked image has two channels in this case. Then, the road regression module may be applied to the stacked image in order to generate the road points feature map.

According to several implementations, the road points feature map comprises a first channel comprising a probability for each image point of the stacked image and, consequently, of the input image that the respective image point corresponds to an entry point or to an exit point.

For example, the values of the first channel of the road points feature map may be between 0 and 1, wherein 1 corresponds to the highest probability that the corresponding image point represents either an entry point or an exit point of the roundabout, and 0 correspond to the lowest probability that the corresponding image point represents either an entry point or an exit point or, in other words, the highest probability for the image point being neither an entry point nor an exit point. In particular, the at least one entry point and/or the at least exit point is determined depending on the first channel.

According to several implementations, the road points feature map comprises a second channel comprising a probability for each image point of the input image that the respective image point corresponds to an entry point.

According to several implementations, the road points feature map comprises a third channel comprising a probability for each image point of the input image that the respective image point corresponds to an exit point.

In particular, the at least one entry point and/or the at least one exit point is determined depending on the second channel and/or the third channel of the road points feature map.

Each road connected to the roundabout is either a road for entering the roundabout or a road for exiting the roundabout. Consequently, an entry point of the roundabout corresponds to a point where a road for entering the roundabout meets the ring approximately defining the roundabout. Analogously, an exit point corresponds to a point where a road for leaving or exiting the roundabout meets the ring.

In terms of the road points feature map, the first channel tells, whether an image point corresponds to either an exit point or to an entry point. If the probability is high enough, in particular, if the probability is equal to or greater than a predefined threshold value, the second and/or the third channel represents the type of the road. For determining the values of the second and/or the third channel, a classification algorithm may be used.

According to several implementations, at least one local maximum of the first channel of the road points feature map is determined by a point extraction module of the trained artificial neural network. The at least one entry point and/or the at least one exit point are determined by the point extraction module depending on the at least one local maximum.

In particular, only local maxima with a value of the first channel beyond the predefined threshold value are considered. In other words, the value of the first channel is equal to or greater than the predefined threshold value for each of the at least one local maxima determined by the point extraction module.

In other words, the point extraction module, which may be a non-trainable module, finds the at least one local maximum in the first channel and then decides according to the second and/or third channel, whether the respective point corresponds to an entry point or to an exit point. In this way, all exit points and all entry points of the roundabout may be determined.

According to alternative implementations, the first channel of the road points feature map comprises a probability for each image point of the input image that the respective image point corresponds to an entry point and/or the second channel of the road points feature map comprises a probability for each image point of the input image that the respective image point corresponds to an exit point.

According to several implementations, the at least one entry point comprises at least two entry points, and the at least one exit point comprises at least two exit point.

According to several implementations, the at least two exit points and the at least two entry points of the roundabout are determined depending on the output of the classificator module and depending on the output of the radius estimation module, in particular as described above. A source point of the at least two entry points and a destination point of the at least two exit points are determined by a recurrent neural network module, RNN-module, of the trained artificial neural network depending on a predefined initial source point for the vehicle and a predefined initial destination point for the vehicle.

The initial source point and the initial destination point may, for example, be determined once at or before starting the roundabout analyzer module, for example based on digital map data. The RNN module may then track the source point and the destination point.

In addition to the predefined initial source point and the predefined initial destination point, an initial location of the vehicle may be provided to the RNN module as an input, and the output of the RNN module may comprise the source point, the destination point and an actual location of the vehicle.

In several implementations, the RNN module comprises a long short-term memory, LSTM, network. LSTM networks are particularly suitable to avoid the so-called long term dependency problem. Therefore, they may remember information for a relatively long period of time. Consequently, by means of the RNN module and, in particular, the LSTM, the source point, the destination point, and the location of the vehicle may be tracked reliably.

According to a further aspect of the invention, a computer-implemented method for planning a path for a vehicle is provided. To this end, a computer-implemented method for analyzing a roundabout in an environment of the vehicle is carried out according to an implementation of the invention as described above. The path for the vehicle is planned by the computing unit depending on the at least one entry point and/or the at least one exit point of the roundabout.

In particular, the path is planned depending on the source point and the destination point and, if applicable, depending on the location of the vehicle.

In particular, planning the path may include generating a trajectory or route leading the vehicle from the source point to the destination point. Algorithms for path planning are per se known and depend on further inputs like digital map information, GPS data, object detection results and so forth. According to the invention, the source and the destination point may be continuously tracked and provided to the path planning algorithm automatically.

According to several implementations, the path for the vehicle is planned depending on the radius feature map. In particular, an input for the path planning comprises the at least one entry point, in particular the source point, the at least one exit point, in particular the destination point, and the radius feature map.

According to a further aspect of the invention, also a method for guiding a vehicle at least in part automatically is provided. To this end, a method for planning a path as described is carried out by a computing unit of the vehicle. At least one control signal for guiding the vehicle at least in part automatically is generated depending on the planned path, in particular by a control unit of the vehicle.

According to a further aspect of the invention, an electronic vehicle guidance system is provided. The electronic vehicle guidance system comprises a computing unit, which is configured to receive at least one camera image from at least one camera of the vehicle and to plan a path for the vehicle depending on the at least one camera image. The electronic vehicle guidance system comprises a control unit, which is configured to generate at least one control signal for guiding a vehicle at least in part automatically depending on the planned path. The computing unit is configured to generate an input image for a trained artificial neural network depending on the at least one camera image, wherein the input image depicts a roundabout in the environment of the vehicle. The computing unit is configured to generate at least one initial feature map by applying a feature encoder module of the trained artificial neural network to the input image and to apply a classificator module of the trained artificial neural network to the at least one initial feature map. An output of the classificator module represents a road region in the input image. The computing unit is configured to apply a radius estimation module of the trained artificial neural network to the at least one initial feature map, wherein an output of the radius estimation module depends on an inner radius of the roundabout and on an outer radius of the roundabout. The computing unit is configured to determine at least one entry point and/or at least one exit point of the roundabout depending on the output of the classificator module and depending on the output of the radius estimation module. The computing unit is configured to plan the path depending on the at least one entry point and/or depending on the at least one exit point.

An electronic vehicle guidance system may be understood as an electronic system, configured to guide a vehicle in a fully automated or a fully autonomous manner and, in particular, without a manual intervention or control by a driver or user of the vehicle being necessary. The vehicle carries out automatically all required functions, such as steering maneuvers, deceleration maneuvers and/or acceleration maneuvers as well as monitoring and recording the road traffic and corresponding reactions. In particular, the electronic vehicle guidance system may implement a fully automatic or fully autonomous driving mode according to level 5 of the SAE J3016 classification. An electronic vehicle guidance system may also be implemented as an advanced driver assistance system, ADAS, assisting a driver for partially automatic or partially autonomous driving. In particular, the electronic vehicle guidance system may implement a partly automatic or partly autonomous driving mode according to levels 1 to 4 of the SAE J3016 classification. Here and in the following, SAE J3016 refers to the respective standard dated June 2018.

Further implementations of the electronic vehicle guidance system follow directly from the various implementations of the computer-implemented method for analyzing a roundabout, the computer-implemented method for planning a path and the method for guiding a vehicle at least in part automatically and vice versa, respectively. In particular, an electronic vehicle guidance system according to the invention is configured to carry out a computer-implemented method or a method according to the invention or carries out such a method.

According to a further aspect of the invention, a computer program comprising instructions is provided. When the instructions are executed by a computer system, in particular by the computing unit of an electronic vehicle guidance system according to the invention, the instructions cause the computer system to carry out a computer-implemented method for analyzing a roundabout according to the invention or a computer-implemented method for planning a path for a vehicle according to the invention.

According to a further aspect of the invention, a further computer program comprising further instructions is provided. When the further instructions are executed by an electronic vehicle guidance system according to the invention, in particular by the computing unit of the electronic vehicle guidance system, the further instructions cause the electronic vehicle guidance system to carry out a method for guiding a vehicle at least in part automatically according to the invention.

According to a further aspect of the invention, a computer-readable storage medium storing a computer program and/or a further computer program according to the invention is provided.

The computer program, the further computer program and the computer-readable storage medium may be denoted as respective computer program products comprising the instructions or the further instructions, respectively.

Further features of the invention are apparent from the claims, the figures and the description of figures. The features and feature combinations mentioned above in the description as well as the features and feature combinations mentioned below in the description of figures and/or shown in the figures alone may not only be encompassed by the invention in the respectively specified combination, but also in other combinations. Thus, implementations of the invention are encompassed and disclosed, which may not explicitly be shown in the figures or explained, but arise from and can be generated by separated feature combinations from the explained implementations. Implementations and feature combinations, which do not have all features of an originally formulated claim, may be encompassed by the invention. Moreover, implementations and feature combinations, which extend beyond or deviate from the feature combinations set out in the relations of the claims, may be encompassed by the invention.

In the Figures:

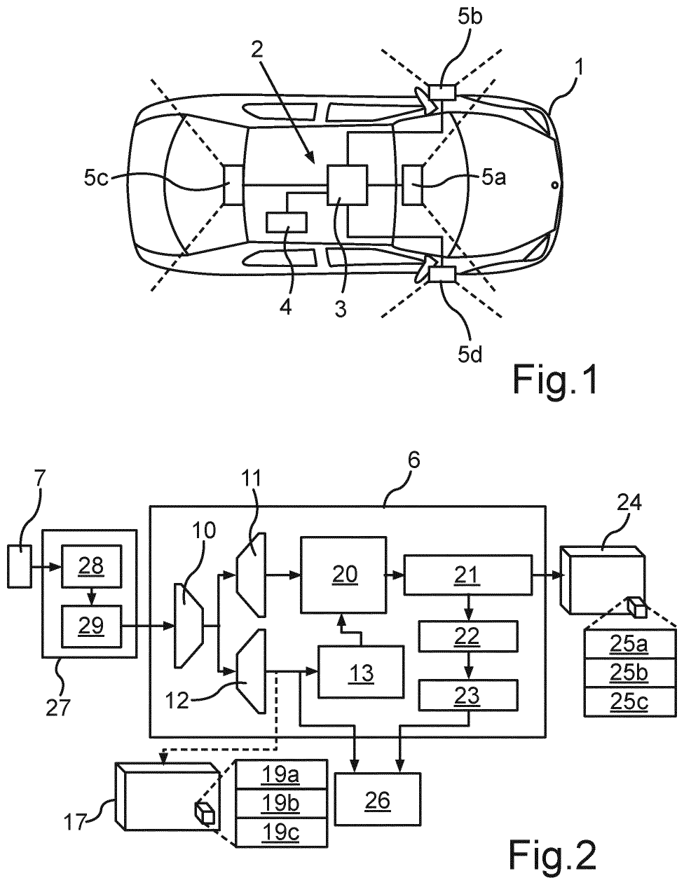

FIG. 1 shows schematically a vehicle comprising an exemplary implementation of an electronic vehicle guidance system according to the invention;

FIG. 2 shows a schematic block diagram of a roundabout analyzer module for use in an exemplary implementation of a computer-implemented method for analyzing a roundabout according to the improved concept; and

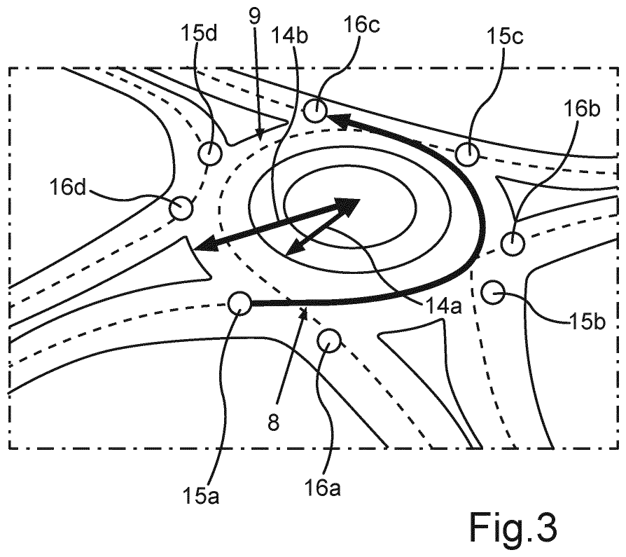

FIG. 3 shows schematically a roundabout from a perspective view.

In FIG. 1, a vehicle 1 is shown, for example a self-driving vehicle, an autonomous car, or another motor vehicle, which is guidable or drivable at least in part automatically. The vehicle 1 comprises an exemplary implementation of an electronic vehicle guidance system 2 according to the invention. The electronic vehicle guidance system 2 comprises a computing unit 3 and a control unit 4. The computing unit 3 as well as the control unit 4 may comprise one or more respective subunits, which may also be spatially distributed.

The electronic vehicle guidance system 2 further comprises cameras 5a, 5b, 5c, 5d, which may, for example, include a front camera 5a, a rear camera 5c, a left camera 5b and a right camera 5d with respective fields of view, which differ from each other and may or may not partially overlap.

The cameras 5a, 5b, 5c, 5d generate camera images according to their respective field of view and provide them to the computing unit 3. The computing unit 3 may generate an input image depending on the camera images, which may, for example, correspond to a common top view image or bird eye view image, wherein a viewing direction is perpendicular to a road surface.

The computing unit 3 is configured to plan a path for the vehicle 1 depending on the input image and the control unit 4 is configured to generate control signals for guiding the vehicle 1 at least in part automatically depending on the planned path. In particular, the control unit 4 may provide the control signals to respective actuators (not shown) of the motor vehicle 1 for guiding the vehicle.

In order to plan the path, the computing unit 3 is configured to carry out a computer-implemented method for analyzing a roundabout according to the invention.

FIG. 2 shows a block diagram representation of a software system of the computing unit 3 in order to execute such a computer-implemented method. The blocks shown in FIG. 2 may, for example, be considered as a roundabout analyzer module. The roundabout analyzer module may be activated by a decision-making module (not shown) of the computing unit 3 in case the decision-making module determines, based on a camera image of the front camera 5a, that a roundabout is present in the environment of the vehicle 1 and has a distance from the vehicle 1, which is equal to or smaller than a predefined maximum distance. When the decision-making module finds that the roundabout is near enough to be analyzed by the roundabout analyzer module, it may generate a corresponding trigger signal, which causes the computing unit 3 to activate the roundabout analyzer module.

The roundabout analyzer module uses the camera images 7 of all cameras 5a, 5b, 5c, 5d for a given frame and converts the camera images 7 to the top view image or bird eye view image as an input image for a trained artificial neural network 6. Therein, the scenario depicted by the camera images 7 depicts a roundabout 9 as shown schematically in FIG. 3. Consequently, also the input image depicts the roundabout 9.

For example, a pre-processing module 27 may comprise an inverse perspective mapping module 28 and a stitching module 29. The inverse perspective mapping module 28 may convert the camera images 7 into individual top view images and the stitching module 29 may combine the individual top view images to the input image. Therein, the inverse perspective mapping module 28 applies a known inverse perspective mapping algorithm to convert each of the camera images to a respective top view image, and the stitching module 29 applies a known stitching algorithm to combine the individual top view images to the input image.

Using a top view image as the input image allows for a better automatized understanding of the surrounding, and, in particular, it helps to understand the position of the vehicle 1 in the complete scene and to make decisions for maneuvers such as parking, turning the vehicle 1 et cetera.

Each of the cameras 5a, 5b, 5c, 5d has corresponding camera parameters, which may be described by two matrices, an intrinsic matrix and an extrinsic matrix. The extrinsic matrix may convert the real-world coordinates to the respective camera coordinates and the intrinsic matrix may convert the camera coordinates to respective image coordinates. In other words, the extrinsic matrix depends on the pose of the respective camera with respect to the vehicle coordinate system or the real-world coordinate system and the intrinsic matrix depends on the mapping function of the respective camera. The mapping function may, in particular, be a non-rectilinear or non-gnomonic function, for example, in case the cameras 5a, 5b, 5c, 5d is are fisheye cameras.

The artificial neural network 6 may comprise a trained feature encoder module 10, which may also be denoted as base encoder and may, for example, comprise a series of convolutional layers for deep feature extraction. The feature encoder module 10 obtains the input image and outputs at least one initial feature map. Roughly speaking, the deeper the feature encoder module 10, in other words the more convolutional layers it has, the better are the features. However, with the number of convolutional layers, also the complexity of the neural network 6 and the computational load for the computing unit 3 are increased. The feature encoder module 10 may be selected based on corresponding constraints of the available computational resources. The feature encoder module 10 may be selected from a standard encoder family such as ResNet, VGG, Inception et cetera.

The artificial neural network 6 also comprises a trained classificator module 11, which may be designed as a road segmentation decoder. The classificator module 11 may also be selected as a pre-trained state of the art decoder to generate a segmented image from the at least one initial feature map, wherein the segmented image represents a road region in the input image. In particular, the segmented image corresponds to a two-channel feature map. One channel provides the information on the road, and the other channel provides the information of everything else but the road. In other words, each image point of the segmented image is assigned to a road class or to a not-road class. The classificator module 11 may therefore comprise a series of de-convolutional layers to reconstruct the segmented image based on the at least one initial feature map. The number of de-convolutional layers of the classificator module 11 is equal to the number of convolutional layers of the feature encoder module 10.

The artificial neural network 6 further comprises a trained radius estimation module 12, which is also designed as a decoder module. Also the radius estimation module 12 comprises a series of de-convolutional layers to be applied to the at least one initial feature map. The number of de-convolutional layers of the radius estimation module 12 is equal to the number of convolutional layers of the feature encoder module 10.

As indicated in FIG. 3, the roundabout 9 comprises a ring-shaped road portion defined by in an inner radius 14a and an outer radius 14b of the roundabout 9. The radius estimation module 12 understands the roundabout 9 from the at least one initial feature map and generates a radius feature map 17 as an output, which has three channels 19a, 19b, 19c.

The first channel 19a comprises the probability for each of the image points to be the center of the roundabout 9. Considering a certain image point as the center, the second and the third channel 19b, 19c provide the regression values for the inner and outer radius 14a, 14b, respectively.

The artificial neural network 6 further comprises a trained masking module 13, which receives the radius feature map 17 as an input and outputs a masked image. In the masked image, the roundabout 9 is represented in a binary manner, for example as black and white pixels. Therein, pixels between the inner radius 14a and the outer radius 14b may, for example, be represented as white pixels, and the other image points may be represented as black pixels. To this end, the masking module 13 may scan the first channel 19a of the radius feature map 17 to find the global maximum of the probability for being the center point. The image point with the global maximum is considered as the center of the roundabout 9. The second and the third channel values of this point are considered as approximations for the inner radius 14a and the outer radius 14b of the roundabout 9. Based thereupon, the masked image is generated.

The artificial neural network 6 further comprises a stack module 20, which is, for example, a non-trainable module. The segmented image resulting from the classificator module 11 and the masked image generated by the masking module 13 are provided as an input to the stack module 20 and the stack module 20 stacks or concatenates them along the depth direction or channel direction. The spatial dimensions of the resulting stacked image are the same as the spatial dimensions of the segmented image and the masked image, respectively.

The roundabout 9 comprises two types of roads meeting the ring portion. One type of road is for entering the roundabout 9 and the other type of the road is for exiting the roundabout 9. Points where the roads for entering the ring meet the ring are denoted as entry points 15a, 15b, 15c, 15d and points where the roads for exiting the ring meet the ring are denoted as exit points 16a, 16b, 16c, 16d, as shown in FIG. 3. To understand the roundabout 9, a trained road regression module 21 of the artificial neural network 6 is used, which receives the stacked image as an input. The road regression module 21 generates a road points feature map 24 as an output depending on the stacked image. In particular, the road points feature map 24 comprises three channels 25a, 25b, 25c. The first channel 25a gives the probability that the respective image point is either an entry point 15a, 15b, 15c, 15d or an exit point 16a, 16b, 16c, 16d.

If the probability of a respective image point is high enough according to the first channel 25a, in other words if the respective value of the first channel 25a is greater than or equal to a predefined minimum probability, the second and third channel 25b, 25c represent the type of the road and, in particular, whether the point corresponds to an exit point 16a, 16b, 16c, 16d or to an entry point 15a, 15b, 15c, 15d. To determine the values for the second and the third channel 25b, 25c, a classification method may be used.

The artificial neural network 6 further comprises a point extraction module 22, which is, in particular, a non-trainable module. The point extraction module 22 takes as an input the road points feature map 24 and extracts the entry points 15a, 15b, 15c, 15d as well as the exit points 16a, 16b, 16c, 16d in terms of image coordinates. To this end, the point extraction module 22 scans the first channel 25a of the road points feature map 24 and determines all local maxima of the respective probability, which have a value that is greater than a predefined minimum probability. These points are considered to represent either an exit point 16a, 16b, 16c, 16d or an entry point 15a, 15b, 15c, 15d of the roundabout 9. The second and the third channel 25b, 25c are used to classify the type of the points accordingly. Consequently, the point extraction module 22 generates all entry points 15a, 15b, 15c, 15d and all exit points 16a, 16b, 16c, 16d of the roundabout 9 as an output.

Furthermore, the artificial neural network 6 comprises a trained RNN module 23, which may, in particular, be implemented as an LSTM. The RNN module 23 may be used to track a source point 15a, a destination point 16c, and a current location of the vehicle 1 over consecutive frames of the camera. Therein, the source point 15a corresponds to one of the entry points 15a, 15b, 15c, 15d and the destination point 16c corresponds to one of the exit points 16a, 16b, 16c, 16d. In particular, a path 8 (see FIG. 3) for the vehicle 1 leads from the source point 15a to the destination point 16c. When the roundabout analyzer module is activated by the decision-making module, an initial position of the source point 15a in the input image, an initial position of the destination point 16c in the input image and an initial position of the vehicle 1 in the input image may be determined from a real world digital map. Once the roundabout analyzer module is running, the RNN module 23 may track the source point 15a and the destination point 15c as well as the vehicle position in the input image. An output of the RNN module 23 comprises the actual source point 15a, the actual destination point 16c and the actual vehicle location in the input image.

According to an exemplary implementation of a computer-implemented method for planning a path 8 for the vehicle 1, the actual source point 15a, the actual destination point 16c and the actual vehicle location may be provided as an input to a path estimator module 26. The path estimator module 26 may also receive the radius feature map 16 directly as a further input. Furthermore, the path estimator module 26 may receive a variety of further inputs from further software algorithms, computer vision algorithms and/or vehicle sensors in order to plan the path 8.

As mentioned, the stack module 20 and the path estimator module 22 may be non-trainable modules. The feature encoder module 10 and the classificator module 11 may be pre-trained. The remaining trained modules, in particular the radius estimation module 12, the road regression module 21 and the RNN module 23 may be trained by means of a common loss function. The training dataset for the common training comprises, for example, multiple captured camera images and the corresponding world map, which shows the desired path as an annotation. All other parameters against which the regression is carried out may also be part of the annotations.

For example, the predicted radius feature map may be expressed as y=[Pᵣ, Rᵢₙ, Rₒᵤₜ] and its corresponding ground truth as y′=[P′ᵣ, R′ᵢₙ, R′ₒᵤₜ]. A standard cross entropy loss for probability map and mean squared error may be used to obtain the radius feature map:

$$L {1}_{p} = {{\sum }^{n - 1}}_{i = 0} {( {P}_{r}^{′} )}^{i} log [ {( {P}_{r} )}^{i} ] ,$$

$$L {1}_{r} = {{\sum }^{n}}_{i = 0} {( {y}^{i} - {( {y}^{′} )}^{i} )}^{2} / n .$$

The predicted road points feature map may be expressed as y=[Pᵣₚ, Lₒᵤₜ, Lᵢₙ] and its corresponding ground truth as [P′ᵣₚ, L′ₒᵤₜ, L′ᵢₙ]. Two separate cross entropy losses may be used for probability map and road classification:

$$L {2}_{p} = {{\sum }^{n - 1}}_{i = 0} {( {P}_{rp}^{′} )}^{i} log [ {( {P}_{rp} )}^{i} ] ,$$

$$L {2}_{r} = {{\sum }^{n - 1}}_{i = 0} {a}_{t}^{i} {log ( {a}_{p} )}^{i} ,$$

where aₚ is the predicted availability and aₜ is its corresponding ground truth.

Regarding the LSTM, source point, destination point and current vehicle position may be denoted by y=[P_{src}, P_{dst}, P_{cur}], its corresponding ground truth by y′=[P′_{src}, P′_{dst}, P′_{cur}]. A mean square error may be used for regression of the output of the LSTM:

$${L}_{lstm} = {{\sum }^{n}}_{i = 0} {( {y}^{i} - {( {y}^{′} )}^{i} )}^{2} / n .$$

Consequently, the total loss function L may be given by:

$$L = L {1}_{p} + L {1}_{r} + L {2}_{p} + L {2}_{r} + {L}_{lstm} .$$

As described, in particular with respect to the figures, the invention provides an improved concept for CNN-based roundabout perception and a corresponding planning system using surround view cameras. A real-time end-to-end modelling of roundabout detection for multiple camera inputs and a mechanism for path planning to the exit of the roundabout may be provided. In particular, the near field sensing capabilities of for surround view cameras may be leveraged for roundabout scenarios.

1. A computer-implemented method for analyzing a roundabout in an environment of a vehicle,
the method comprising:
generating at least one initial feature map by applying a feature encoder module of a trained neural network to an input image,
wherein the input image depicts the roundabout;
applying a classificator module of the trained neural network to the at least one initial feature map,
wherein an output of the classificator module represents a road region in the input image;
applying a radius estimation module of the trained neural network to the at least one initial feature map,
wherein an output of the radius estimation module depends on an inner radius of the roundabout and an outer radius of the roundabout; and
determining at least one entry point and at least one exit point of the roundabout depending on the output of the classificator module and depending on the output of the radius estimation module.

2. The computer-implemented method according to claim 1,
wherein the output of the classificator module comprises a segmented image,
wherein the road region comprises image points of the segmented image, which are assigned to a road class by applying the classificator module to the at least one initial feature map.

3. The computer-implemented method according to claim 2,
wherein the output of the radius estimation module comprises a mask image,
wherein the mask image defines a ring with an inner ring radius approximating the inner radius of the roundabout and with an outer ring radius approximating the outer radius of the roundabout.

4. The computer-implemented method according to claim 3,
wherein applying the radius estimation module to the at least one initial feature map comprises applying a radius regression sub-module of the radius estimation module to the at least one initial feature map, and
wherein an output of the radius regression sub-module comprises a radius feature map;
wherein the radius feature map comprises a first channel comprising a probability for each image point of the input image that the respective image point corresponds to a center of the roundabout;
wherein the radius feature map comprises a second channel comprising a regression value for the inner radius of the roundabout for each image point of the input image; and
wherein the radius feature map comprises a third channel comprising a regression value for the outer radius of the roundabout for each image point of the input image.

5. The computer-implemented method according to claim 4,
wherein a global maximum of the first channel of the radius feature map is determined by a masking sub-module of the radius estimation module;
wherein the inner ring radius is determined by the masking sub-module as the regression value for the inner radius of the roundabout corresponding to the global maximum; and
wherein the outer ring radius is determined by the masking sub-module as the regression value for the outer radius of the roundabout corresponding to the global maximum.

6. The computer-implemented method according to claim 3,
further comprising:
applying a road regression module of the trained neural network to a combination of the segmented image and the masked image,
wherein an output of the road regression module comprises a road points feature map; and
determining the at least one entry point and the at least one exit point depending on the road points feature map.

7. The computer-implemented method according to claim 6,
wherein the road points feature map comprises a first channel comprising a probability for each image point of the input image that the respective image point corresponds to an entry point or to an exit point.

8. The computer-implemented method according to claim 7,
wherein the road points feature map comprises a second channel comprising a probability for each image point of the input image that the respective image point corresponds to an entry point; and
wherein the road points feature map comprises a third channel comprising a probability for each image point of the input image that the respective image point corresponds to an exit point.

9. Computer-implemented method according to claim 7, further comprising:
determining at least one local maximum of the first channel of the road points feature map by a point extraction module of the trained neural network;
determining the at least one entry point and the at least one exit point is determined by the point extraction module depending on the at least one local maximum.

10. The computer-implemented method according to claim 6,
wherein the road points feature map comprises a first channel comprising a probability for each image point of the input image that the respective image point corresponds to an entry point; and
wherein the road points feature map comprises a second channel comprising a probability for each image point of the input image that the respective image point corresponds to an exit point.

11. The computer-implemented method according to claim 1,
further comprising:
determining at least two entry points and at least two exit points of the roundabout depending on the output of the classificator module and depending on the output of the radius estimation module;
determining a source point of the at least two entry points and a destination point of the at least two exit points by a recurrent neural network module of the trained neural network depending on a predefined initial source point and a predefined initial destination point for the vehicle.

12. The computer-implemented method according to claim 1,
further comprising converting two or more camera images to a common top view image in order to generate the input image.

13. Computer implemented A computer-implemented method for planning a path for a vehicle,
the method comprising:
carrying out a computer-implemented method for analyzing a roundabout in an environment of the vehicle according to claim 1; and
planning the path for the vehicle depending on the at least one entry point and at least one exit point of the roundabout.

14. An electronic vehicle guidance system comprising:
a computing unit, which is configured to receive at least one camera image from at least one camera of the vehicle and to plan a path for the vehicle depending on the at least one camera image; and
a control unit, which is configured to generate at least one control signal for guiding a vehicle at least in part automatically depending on the planned path;
wherein the computing unit is configured to:
generate an input image for a trained neural network depending on the at least one camera image, the input image depicting a roundabout in an environment of the vehicle;
generate at least one initial feature map by applying a feature encoder module of the trained neural network to the input image;
apply a classificator module of the trained neural network to the at least one initial feature map,
wherein an output of the classificator module represents a road region in the input image;
apply a radius estimation module of the trained neural network to the at least one initial feature map,
wherein an output of the radius estimation module depends on an inner radius of the roundabout and an outer radius of the roundabout;
determine at least one entry point and at least one exit point of the roundabout depending on the output of the classificator module and depending on the output of the radius estimation module; and
plan the path depending on the at least one entry point and at least one exit point.

15. A non-transitory computer readable medium containing program instructions for causing a processor to perform a computer-implemented method according to claim 1.
